(19) United States
(12) Patent Application Publication
(10) Pub. No.: US 2020/0216257 A1
(43) Pub. Date: Jul. 9, 2020

(54) SINGLE-DOSE CAPSULE FOR THE PRODUCTION OF BEVERAGES

(71) Applicant: RDL S.R.L., San Giorgio di Piano (BO) (IT)

(72) Inventors: Alberto ZAPPOLI, Sasso Marconi (BO) (IT); Roberto DEMONTIS, Sala Bolognese (BO) (IT)

(21) Appl. No.: 16/626,241

(22) PCT Filed: Jun. 27, 2018
(86) PCT No.: PCT/IB2018/054757

§ 371 Date: Dec. 23, 2019

(30) Foreign Application Priority Data
Jun. 29, 2017 (IT) 102017000073146

(51) Int. Cl. B65D 85/804

(52) U.S. Cl. CPC B65D 85/8046; A47J 31/407

(57) ABSTRACT

A capsule for powder or semi-liquid food products includes: a hollow rigid body forming a chamber for a dose of product and having a base and upper opening. A cover closes the opening. Elements for controlled flow of a solvent toward the chamber are formed on the cover and result in thrust on the cover via pressure of the solvent, to allow sliding of the cover, guided by walls of the body, from the opening towards the base with pushing on the dose. Notches on the base act as flexible membranes to obtain an opening of the base, at the thrust of the cover, and allow the passage of the dose towards a connecting duct. Elements retaining the cover on the opening are positioned between the cover and an annular zone of the opening of the body, and temporarily retain the cover up to the start of the thrust.

### TECHNICAL FIELD

This invention relates to a single-dose capsule for powder or semi-liquid products.

More specifically, the capsule according to this invention can be used on machines for producing either a hot product (infusion beverages such as coffee, tea, camomile, etc.) or a cold product (ice cream).

### BACKGROUND ART

A machine of this kind is known from patent document WO2015092637 in the name of the same Applicant.

These machines comprise a chamber for housing the capsule. The chamber comprises a zone for feeding or flow of a solvent fluid (hot or cold) and a discharging zone, where the product already partly mixed is fed, for example, to a processing chamber (for example a mixing and cooling unit, in the case of a cold product, or a percolating chamber in the case of a hot product)

Currently, as described in the above-mentioned patent document, the prior art capsules contain a food preparation (that is to say, a mixture of ingredients, ready for use or concentrated) for the preparation of a food product such as: ice creams, sorbets, slush drinks, cold custards and puddings, or, coffee, tea, camomile, etc.

These food preparations, depending on the type of end product, may consist of mixtures of dry powder, or semi-liquid granulated gel mixtures.

These capsules, as mentioned above of the single-dose type, are structured to favour the dilution with a predetermined quantity of solvent liquid which is transferred and made to flow through the capsule before reaching the dispensing conduit. The mixture is transferred into a processing or extraction chamber.

An example of this capsule is also shown in the patent document WO2015092637 in the name of the same Applicant.

The capsule basically comprises:

a cylindrical shaped body, closed at the bottom, defining the chamber for housing the food product;
a tubular protuberance, positioned inside the cylindrical body, configured with an upper opening, and a lower opening in communication with the outside;
an upper body or cover of the body for the relative sealed closing; the cover, when mounted, temporarily closes the upper opening of the projection.

A plurality of through holes is made at an annular zone of the cover.

These holes are designed to allow the entry of the solvent liquid inside the capsule for mixing with the powder or semi-liquid product and also act as an element for complete emptying of the product from the capsule.

In effect, the emptying occurs since the solvent liquid, as it is introduced inside the capsule under great pressure, allows a slight deformation of the cover upwards with relative detachment from the central protuberance freeing, in effect, the upper opening. The upper opening allows the passage of the flow of the resulting mixture towards the outside, that is to say, outside the lower opening.

This solution of capsule has several drawbacks.

A first drawback is due to the reduced use of the quantity of product housed inside the capsule.

In effect, the flow of the solvent liquid with relative mixing inside the capsule starts from the bottom upwards to allow the opening of the protuberance at the top with the passage of the mixture downwards. Now, when the flow of the solvent liquid terminates and the internal pressure drops, a part of the mixture is not able to reach the outfeed zone and remains inside the capsule.

This determines an end product which is not coherent (that is to say, of poorer quality) with the real quantity of product present in the capsule.

Another drawback is due to the fact that the used capsules remain soiled and cannot be fully recycled in an immediate fashion, with the need for intermediate processing which is more costly.

### Aim of the Invention

The aim of this invention is to provide a single-dose capsule for powder or semi-liquid products which overcomes the above mentioned drawbacks of the prior art.

More specifically, the aim of this invention is to provide a single-dose capsule for powder or semi-liquid food products which is able to obtain a controlled and complete flow of the quantity of food product inside the processing or percolating chamber.

A further aim of this invention is to provide a single-dose capsule for powder or semi-liquid products which is able to obtain, depending on the type of final product housed, a high quality of final mixture inside the processing chamber.

These aims are fully achieved by the single-dose capsule for powder or semi-liquid products according to the invention as characterised in the appended claims.

### BRIEF DESCRIPTION OF THE DRAWINGS

The features of the invention will become more apparent from the following detailed description of a preferred, non-limiting embodiment of it, illustrated by way of example in the accompanying drawings, in which:

FIG. 1 illustrates a schematic side view with some parts cut away to better illustrate others of a capsule for powder or semi-liquid products, according to this invention, housed in a seat of a machine for its use;

FIG. 2 illustrates a front view with some parts cut away to better illustrate others of the capsule for powder or semi-liquid products;

FIG. 3 illustrates a cross section view of an enlarged detail of FIG. 2;

FIG. 4 illustrates a top plan view of the capsule of the above-mentioned drawings;

FIG. 5 is a cross-section through line V-V of FIG. 4;

FIG. 6 illustrates a bottom plan view of the capsule of the above-mentioned drawings;

FIG. 7 is a cross-section through line VII-VII of FIG. 6;

FIG. 8 illustrates a top plan view of another embodiment of the capsule of the above-mentioned drawings;

FIG. 9 is a cross-section through line IX-IX of FIG. 8.

### DETAILED DESCRIPTION OF PREFERRED EMBODIMENTS OF THE INVENTION

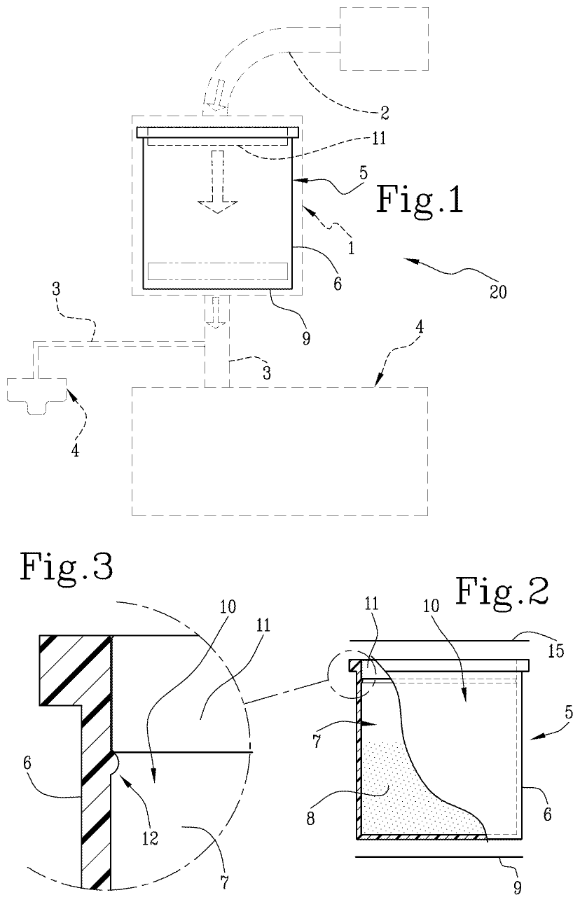

With reference to the accompanying drawings, and in particular to FIG. 1, the capsule for powder or semi-liquid food products (or also liquids) according to the invention, denoted in its entirety by the numeral 5, can be used in machines for preparing hot or cold products (for example single-dose ice creams or water-ices or hot infusions such as coffee, tea or the like).

The machine, labelled 20 in its entirety, will not be described in detail, since it can be, for example, of the type illustrated in the patent document WO2015092637 in the name of the same Applicant.

Basically, the machine (see FIG. 1) has a seat 1 in which can be housed the capsule 5.

The machine has an inlet conduit 2 of a solvent liquid and a conduit 3 connecting with a chamber 4 for receiving the mixed product (for example a product mixing chamber or a product percolating chamber both labelled 4 in FIG. 1).

The capsule 5 comprises a hollow rigid body 6 (preferably with cylindrical cross-section and single piece) defining a chamber 7 for housing a dose 8 of powder or semi-liquid food product (that is, a powder material product with reduced grain size, or a gel).

The rigid body 6 has a base 9 and a top opening 10 open to the outside.

The capsule 5 has a cover 11 for closing the top opening 10 of the rigid body 6.

It should be noted that the cover 11 is also of the rigid type.

As illustrated (see also FIG. 2), the capsule 5 comprises a plurality of elements 13 for the controlled passage of the flow of solvent liquid towards the housing chamber 7, made on a surface of the cover 11 and configured for obtaining, selectively and as a function of a pressure of the solvent liquid flowing, the passage of a reduced quantity of the solvent liquid towards the chamber 7 for housing the dose 8 of product and a simultaneous thrust on the cover 11, generated by the pressure of the solvent liquid flowing, so as to allow the cover 11 to slide inside the housing chamber 7, guided by the inner rigid walls (that is, by the inner cylindrical surface) of the rigid body 6, from the top opening 10 towards the base 9 of the rigid body 6 with relative pushing on the dose 8 of product.

The capsule 5 comprises a plurality of notches 14 made on the base 9 of the body 6 which are able to define portions of the base 9 which are adjacent to one another and acing as flexible membranes to obtain an opening of the base 9, at the thrust of the cover 11 on the dose 8 of product, and allow the passage the dose 8 of product towards the connecting conduit 3.

Preferably, the capsule 5 also comprises elements 12 for retaining the cover 11 on the opening 10 of the rigid body 6, positioned between the cover 11 and an annular zone of the top opening 10 of the rigid body 6, and configured for temporarily retaining the cover 11 on the opening 10 of the rigid body 6 up to the start of the thrust generated by the solvent liquid on the cover 11.

In other words, the capsule is structured in such a way as to push (with a syringe or piston effect) the entire dose of product towards the chambers for processing the product with a reduced quantity of liquid mixed with the product.

The times for ejection of the product are reduced and the end quality of the product flowing out is extremely high.

Preferably (see FIG. 3), the retaining elements comprise an annular projection 12 elastically compliant positioned inside and along an inner edge of the body 6 close to the top opening 10. The annular projection 12 is configured to release the cover 11 and allow the sliding movement of the cover 11 at the thrust generated by the solvent liquid on the cover 11.

Basically, the projection 12 has a resistance lower than the pushing pressure obtained from the flowing liquid acting on the surface of the cover 11.

According to an alternative solution (or in combination with the projection 12), the retaining elements (FIG. 2) can comprise a microperforated piece 16 of film positioned to cover the edge of the body 6 forming the frame of the top opening 10 and the cover 11 in a covering position. In light of this, the piece 16 is partly associated with the edge of the rigid body 6 and the cover 11 (for example by heat sealing), in such a way as to release the cover 11 at the thrust generated by liquid the solvent on the cover 11.

In other words, the piece 16 (microperforated) serves to keep the cover 11 in the closed position of the rigid body 6, but with a seal less than the force generated by the liquid on the surface of the cover 11 in such a way as to allow the sliding of the cover 11 towards the base of the body.

According to a further alternative solution, the capsule 5 comprises a piece of flat circular flexible film or cover (for example, made of aluminium) for joining and seal between the edge of the rigid body 6 and the cover 11.

The cover can be removed before use of the capsule 5.

With this solution it is possible to have only the closing cover with the cover 11 retained, in a floating fashion, by the dose of product contained until activation of the mixing procedure which, in effect, define the retaining elements.

Alternatively, the cover can be combined with the retaining elements described above.

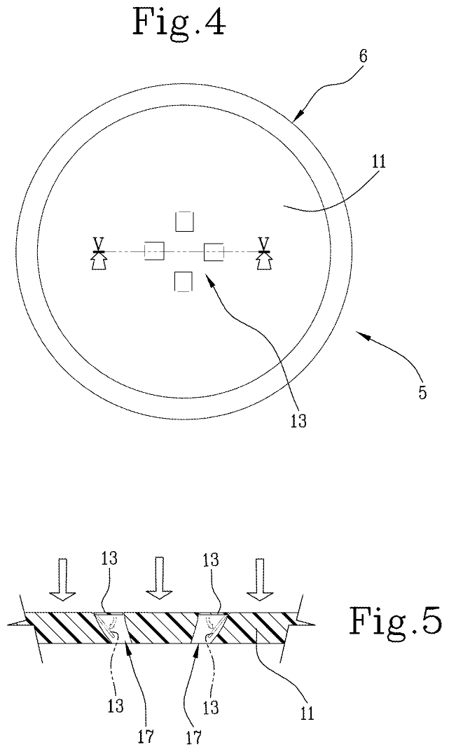

Preferably, the passage means (FIGS. 4 and 5) are a plurality of valve elements 13 made on the surface of the cover 11 and configured for moving between a closed position to define, with the rest of the cover 11, a contact surface on the solvent liquid flowing, which is able to generate the thrust on the cover 11 and thus allow the cover 11 to slide towards the base 9 of the body 10 with relative thrust on the dose 8 of product, and an open position for the passage of a reduced quantity of the solvent liquid towards the chamber 7 for housing the dose 8 of product.

This valve structure makes it possible to obtain a high contact surface of the cover so as to reduce the time for lowering the cover and, simultaneously, to achieve the flow of the quantity, even though reduced of liquid in the dose of product to obtain the correct and necessary mixing (in particular for powder products) necessary for the correct escape of the product from the capsule.

In light of this, each valve element can comprise a flexible plate 13 formed on the outer surface of the cover 11 (in the case illustrated, only by way of example, there are four) and having an end constrained to the outer surface of the cover 11.

Each plate 13 has an elastic surface movable between a closed static position, coplanar with the outer surface of the cover 11, and an open position, wherein the plate 13 is inclined towards the housing chamber 7, under the thrust of the solvent liquid flowing, so as to allow a reduced passage of the solvent liquid towards a corresponding passage hole 17 made in the cover 11 and under the plate 13.

The number, the size, the rigidity of the plates (and their position on the surface of the cover) are a function of the response to be obtained by the plates to the thrust of the solvent liquid and by the amount of liquid to be passed towards the dose of product.

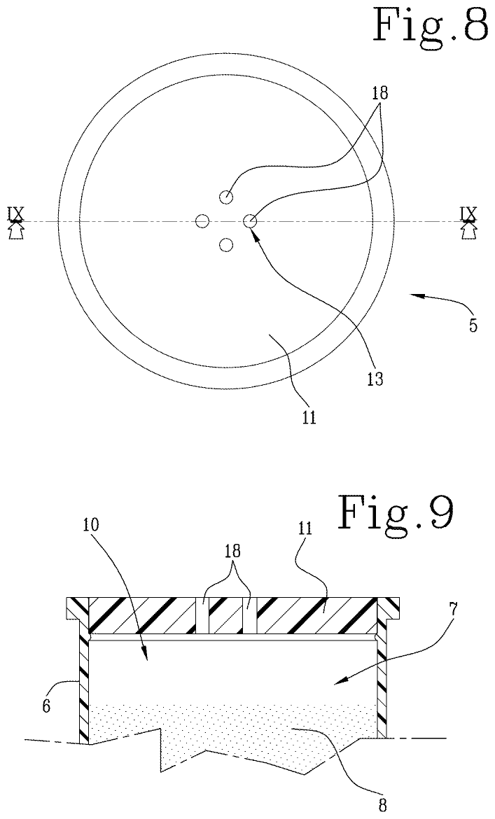

According to a variant embodiment illustrated in FIGS. 8 and 9, the controlled passage elements can comprise two (or more) through holes 18, with reduced diameter, made in the proximity of the centre of the cover 11, to allow a reduced and controlled passage of the solvent liquid towards the chamber 7 for housing the product at the flow of the solvent liquid and, at the same time, always allow the pushing of the solvent liquid flowing on the cover 11, in such a way as to push the cover 11 towards the base 8 of the rigid body 6.

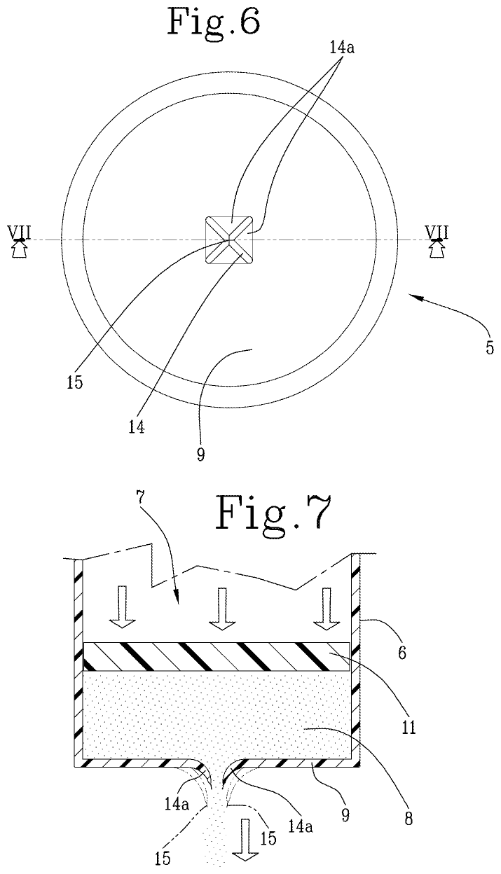

Preferably, the plurality of notches 14 is made on the base 9 of the rigid body 6 to form a cross close to the centre of the base 9 of the rigid body 9 and to define four flaps 14a acting as flexible membranes (FIGS. 6 and 7).

The flaps 14a (of educed thickness) are configured to bend towards the outside of the body 10, at the thrust generated by the cover 11 on the dose 8 of product with consequent escape of the dose 8 of product from the housing chamber 7.

Preferably, the flaps 14a can be joined together by a stretch of the base 9 in a shared central point defining a breaking joining element 15.

In light of this, the breaking joining element 15 being a portion of the base 9 having a reduced thickness relative to the thickness presented by the flaps 14a in such a way as to mutually separate the flaps 14a at the thrust of the cover 11 on the dose 8 of product.

In addition (by way of a non-limiting example) the capsule 5 may comprise a piece of film 19 for closing the base 9 and which can be removed from base 9 before use. This to guarantee the closing of the base in the case of very fine powder products.

The invention also provides a method for feeding a dose of product with the capsule 5 described above.

The method comprises the following steps:

preparing a processing machine with a seat 1 connected to an inlet conduit 2 of a solvent liquid and a conduit 3 connecting with a chamber 4 for receiving the product; preparing a capsule 5 according to one or more of the features described above;
housing the capsule 5 in the seat 1;
flowing of the solvent liquid in the seat 1 towards the cover 11 of the capsule 5;
guided sliding of the cover 11, along the entire rigid body 6 and inside the housing chamber 7, towards the base 9 of the rigid body 6 by means of the thrust of the liquid solvent flowing;
partial passage of the liquid solvent in the housing chamber 7, through the cover 11 and using the means 13 for the controlled flow of the liquid, with partial mixing in the housing chamber 7 between the dose 8 of product and the part of the liquid solvent which has entered;
escape of the dose 8 of product partly mixed through the opening of the base 9 of the rigid body 6 defined by notches 14 and under the thrust of the cover 11 in a guided downwards fashion, using the inner surfaces of the rigid body 6, towards the base 9 of the rigid body 6.

Preferably, after the step of escape of the dose 8 of product partly mixed and with the cover 11 resting on the base 9 of the rigid body 6, there is a step of rinsing the chamber 7 for housing the capsule 5 with the remaining liquid flowing inside the housing chamber 7.

The preset aims are achieved thanks to a capsule structured in this way.

The basic concept of the capsule lies in the fact that the cover acts as an actual extraction element of the product, using the thrust force of the liquid flowing, and it is correctly guided by the rigid inner surfaces of the rigid body.

The valve elements guarantee a minimum quantity of liquid for the small percentage of mixing necessary (in particular for powder products) without reducing the final quality of the product.

This type of system guarantees the complete extraction of the dose of product (therefore high final quality) with standard extraction times and without having to modify the existing machine.

The closing of the bottom by the cover makes it possible to perform a complete rinsing of the capsule already in the machine so as to recycle the used capsule (the body and cover of which maintain their shape thanks to their stiffness) without further intermediate processes.

1. A capsule for powder or semi-liquid food products which can be used in a machine having a seat for housing a capsule of product, an inlet conduit of a solvent liquid and a conduit connecting with a chamber for receiving the mixed product; the capsule comprising at least:
a hollow rigid body forming a chamber for housing a dose of powder or semi-liquid food product; the rigid body having a base and a top opening open to the outside;
a cover for closing the top opening of the rigid body;
wherein it comprises:
a plurality of elements for the controlled passage of the flow of liquid towards the housing chamber, made on a surface of the cover and configured for obtaining, selectively and as a function of a pressure of the solvent liquid flowing, the passage of a reduced quantity of the solvent liquid towards the chamber for housing the dose of product and a simultaneous thrust on the cover, generated by the pressure of the solvent liquid flowing, so as to allow the cover to slide inside the housing chamber, guided by inner rigid walls of the rigid body, from the top opening towards the base of the rigid body with relative pushing on the dose of product;
a plurality of notches made on the base of the rigid body which are able to define portions of the base which are adjacent to one another and acting as flexible membranes to obtain an opening of the base, at the thrust of the cover on the dose of product, and allow the passage the dose of product towards the connecting conduit.

2. The capsule according to claim 1, comprising the elements for retaining the cover on the opening of the rigid body, positioned between the cover and an annular zone of the top opening of the rigid body, and configured for temporarily retaining the cover on the opening of the rigid body up to the start of the thrust generated by the solvent liquid on the cover.

3. The capsule according to claim 2, wherein the retaining elements comprise an annular projection elastically compliant positioned inside and along an inner edge of the rigid body close to the top opening; the annular projection being configured for releasing the cover and allowing the guided sliding movement of the cover inside the housing chamber at the thrust generated by the solvent liquid on the cover.

4. The capsule according to claim 2, wherein the retaining elements comprise a microperforated piece of film positioned to cover the edge of the rigid body forming the frame of the top opening and the cover in a covering position; the piece being partly associated with the edge of the rigid body and the cover, in such a way as to release the cover at the thrust generated by liquid the solvent on the cover.

5. The capsule according to claim 1, comprising a piece of flat circular flexible film or cover for joining and sealing between the edge of the rigid body and the cover which can be removed before use of the capsule.

6. The capsule according to claim 1, wherein the passage means are a plurality of valve elements made on the surface of the cover and configured for moving between a closed position to define, with the rest of the cover, a contact surface on the solvent liquid flowing, which is able to generate the thrust on the cover and thus allow the cover to slide towards the base of the body with relative thrust on the dose of product, and an open position for the passage of a reduced quantity of the solvent liquid towards the chamber for housing the dose of product.

7. The capsule according to claim 6, wherein each valve element comprises a flexible plate formed on the outer surface of the cover and having an end constrained to the outer surface of the cover; each plate having an elastic surface movable between a closed static position, coplanar with the outer surface of the cover, and an open position, wherein the plate is inclined towards the housing chamber, under the thrust of the solvent liquid flowing, so as to allow a reduced passage of the solvent liquid towards a corresponding passage hole made in the cover and under the plate.

8. The capsule according to claim 1, wherein the controlled passage elements comprise at least two through holes, with reduced diameter, made in the proximity of the centre of the cover, to allow a reduced and controlled passage of the solvent liquid towards the chamber for housing the product at the flow of the solvent liquid and, at the same time, allow the pushing of the solvent liquid flowing on the cover, in such a way as to push the cover towards the base of the rigid body.

9. The capsule according to claim 1, wherein the plurality of notches is made on the base of the rigid body to form a cross close to the centre of the base of the rigid body and to define four flaps acting as flexible membranes; the flaps being configured to bend towards the outside of the body, at the thrust generated by the cover on the dose of product with consequent escape of the dose of product from the housing chamber.

10. The capsule according to claim 9, wherein the flaps are joined together by a stretch of the base in a shared central point defining a breaking joining element; the breaking joining element being a portion of the base having a reduced thickness relative to the thickness presented by the flaps in such a way as to mutually separate the flaps at the thrust of the cover on the dose of product.

11. The capsule according to any claim 1, comprising a piece of film closing the base which can be removed from the base before use.

12. A method for feeding a dose of product with a capsule according to claim 1, comprising the following steps:
preparing a processing machine with a seat connected to an inlet conduit of a solvent liquid and a conduit connecting with a chamber for receiving the product;
preparing the capsule;
housing the capsule in the seat;
flowing of the solvent liquid in the seat towards the cover of the capsule;
guided sliding of the cover, along the entire rigid body and inside the housing chamber, towards the base of the rigid body by means of the thrust of the liquid solvent flowing;
partial passage of the liquid solvent in the housing chamber, through the cover and using the means for the controlled flow of the liquid, with partial mixing in the housing chamber between the dose of product and the part of the liquid solvent which has entered;
escape of the dose of product partly mixed through the opening of the base of the rigid body defined by notches and under the thrust of the cover in a guided downwards fashion, using the inner surfaces of the rigid body, towards the base of the rigid body.

13. The method according to claim 12, wherein after the step of escape of the dose of product partly mixed and with the cover resting on the base of the rigid body, there is a step of rinsing the chamber for housing the capsule with the remaining liquid flowing inside the housing chamber.
